(19) United States
(12) Patent Application Publication
(10) Pub. No.: US 2025/0020884 A1
(43) Pub. Date: Jan. 16, 2025

(54) TELECOMMUNICATIONS OUTLET DEVICE CONFIGURED TO PROVIDE IMPROVED CONNECTION DENSITY

(71) Applicant: BELDEN CANADA ULC, SAINT-LAURENT (CA)

(72) Inventors: Jaber AHMAD, Montreal (CA); MICHAEL BODZAY, Dollard-des-Ormeaux (CA)

(73) Assignee: BELDEN CANADA ULC, SAINT-LAURENT (CA)

(21) Appl. No.: 18/771,576

(22) Filed: Jul. 12, 2024

Related U.S. Application Data
(60) Provisional application No. 63/526,226, filed on Jul. 12, 2023.

(51) Int. Cl. G02B 6/44

(52) U.S. Cl. CPC G02B 6/4471

(57) ABSTRACT

A telecommunications outlet device structurally configured to be expanded to provide increased connection density. The device may include a top portion, a body portion structurally configured to attach to the top portion and defining an interior volume, and a mounting portion associated with the body portion. The body portion and the top portion may be structurally configured to mount a second body portion, defining a second interior volume, between the top portion and the body portion in a stacked configuration such that the second body portion is attached to both the body portion and the top portion.

### CROSS-REFERENCE TO RELATED APPLICATIONS

This application claims the benefit of U.S. Provisional Patent Application No. 63/526,226, filed on Jul. 12, 2023, the disclosure of which is fully incorporated herein by reference in its entirety.

### BACKGROUND

The present disclosure relates generally to telecommunications systems and, in particular, to an outlet device for use with telecommunications systems.

Multi-media boxes are often conventionally designed with fixed port counts. Whether those ports are in the form of copper data connectors (Keystone style or MDVO style) or fiber connectors (fiber adapters of any form, SC/LC/MPO/SN) or a combination. The boxes can be designed with two entry types, side entry and rear entry. For side entry, there can be an opening (or sometimes knockouts) positioned at one or more locations on the sides of the boxes. For rear entry there can be an opening in the back mounting plate of the box such that a cable can pass through the wall into the boxes. Typically, the rear entry is used with recessed electrical boxes or support bracket.

The side entry method provides flexibility in deployment because the cable can be run along the wall to the required connection point with the box. The box is attached to the wall and can be moved, if necessary, provided there is enough slack in the cable. In this type of deployment, the cable and box can be installed later in the building process once the location of the connecting devices (cameras, WiFi, etc.) are known.

The rear entry method provides a cleaner aesthetic without the cable running along the wall to the box. The only cable seen is the patch cord used to interconnect the box with the device. However, the locations must be predetermined because the cable must be run in the wall, and electrical boxes or support brackets must be installed.

In the case of a side entry, if additional ports are needed at a particular location, a second box can be mounted adjacent to the first. This occupies a greater wall surface area.

In the case of a rear entry, adding ports is more complicated. Depending on the building construction, in some circumstances, it may not be feasible and the only method to add more ports will be to install a second box with side entry, negating the aesthetic appeal of the first rear entry box.

It may be desirable to provide a telecommunications outlet device that is configured to provide increased connection density. For example, it may be desirable to provide a device that permits body portions to be stacked on one another so as to provide increased connection density of the device without increasing a footprint of the mounting portion on the surface.

### SUMMARY

The present disclosure provides a telecommunications outlet device configured to be expanded to provide increased connection density. The telecommunications outlet device may include a top portion, a body portion structurally configured to attach to the top portion, and a mounting portion associated with the body portion and structurally configured to mount the device to a surface.

In some embodiments, the body portion may define an interior volume for receiving one or more communication cables.

In some embodiments, the body portion and the top portion may be structurally configured to mount a second body portion, defining a second interior volume, between the top portion and the body portion in a stacked configuration such that the second body portion is attached to both the body portion and the top portion.

In some embodiments, the body portion may define a footprint and the second body portion fits within the footprint.

In some embodiments, the body portion may include an opening structurally configured to connect the interior volume of the body portion to the second interior volume of the second body portion.

In some embodiments, the mounting portion may be structurally configured to be removably attached to the body portion.

In some embodiments, the mounting portion may be structurally configured to be removably attached to the body portion.

In some embodiments, the mounting portion may include a body portion attachment portion structurally configured to attach to a mounting portion attachment portion of the body portion.

In some embodiments, the body portion may include a body back wall portion and a body side wall portion that is structurally configured to extend from the body back wall portion.

In some embodiments, the body side wall portion may include a wall extension that includes the top portion attachment portion.

In some embodiments, the top portion may include a clip, and the body portion may include a protrusion adjacent a recess in the wall extension, and wherein the clip is structurally configured to engage the protrusion to resist removal of the top portion from the body portion.

In some embodiments, the top portion may include a top wall portion and the body side wall portion may include a recessed portion structurally configured to receive at least a portion of the top wall portion.

In some embodiments, a telecommunications outlet device configured to be expanded to provide increased connection density may include a mounting portion structurally configured to be mounted to a surface, a body portion structurally configured to attach to the mounting portion, and a top portion structurally configured to attach to the body portion.

In some embodiments, the mounting portion may include a mounting portion side wall portion that includes a body portion attachment portion.

In some embodiments, the body portion may include a body back wall portion and a body side wall portion that is structurally configured to extend from the body back wall portion.

In some embodiments, the body back wall portion and the body side wall portion may be structurally configured to define an interior volume of the body portion.

In some embodiments, the body side wall portion may include a mounting portion attachment portion that extends inwardly from the body side wall portion and a top portion attachment portion.

In some embodiments, the top portion may include a top wall portion and a body portion attachment portion that extends inwardly from the top wall portion.

In some embodiments, the body portion side wall portion may be structurally configured to receive the body portion attachment portion of the top portion to attach the top portion to the body portion.

In some embodiments, thee body portion attachment portion of the mounting portion side wall portion may be structurally configured to engage the mounting portion attachment portion of the body side wall portion to attach the mounting portion to the body portion.

In some embodiments, the body side wall portion may include a wall extension that includes the top portion attachment portion.

In some embodiments, the body portion attachment portion of the top portion may include a clip, and the top portion attachment portion of the body portion may include a protrusion adjacent a recess in the wall extension. In some embodiments, the clip may be structurally configured to engage the protrusion to resist removal of the top portion from the body portion.

In some embodiments, the top portion may be structurally configured to be detached from the body portion.

In some embodiments, the top portion attachment portion of the body may be structurally configured to engage a mounting portion attachment portion of a second body portion.

In some embodiments, the body portion attachment portion of the top portion may be structurally configured to engage a top portion attachment portion of the second body portion such that the second body portion is permitted to be stacked on the body portion so as to provide increased connection density of the device without increasing a footprint of the mounting portion on the surface.

In some embodiments, the mounting portion may include a back plate.

In some embodiments, an outer surface of the top wall portion may be configured to be aligned with an outer surface of the body portion side wall portion when the top portion is attached to the body portion.

In some embodiments, the body portion side wall portion may include one or more cable entry openings.

In some embodiments, the body back wall portion may include one or more cable passthrough openings structurally configured to connect the interior volume of the body portion to an interior volume of the second body portion.

In some embodiments, the top wall portion of the top portion may be structurally configured to elastically deform outwardly to allow the clip to pass over the catch and then move inwardly to engage the recess.

In some embodiments, the top wall portion may include a first adapter opening and the body wall portion may include a second adapter opening that together form a receptacle for receiving an adapter.

In some embodiments, a telecommunications outlet device may be configured to be expanded to provide increased connection density. The telecommunications outlet device may include a top portion, a body portion structurally configured to attach to the top portion, and a mounting portion associated with the body portion.

In some embodiments, the top portion may include a body portion attachment portion.

In some embodiments, the body portion may be structurally configured to attach to the top portion.

In some embodiments, the body portion may define an interior volume for receiving one or more communication cables.

In some embodiments, the body portion may include a top portion attachment portion.

In some embodiments, the mounting portion may be structurally configured to mount the device to a surface.

In some embodiments, the top portion attachment portion of the body portion may be structurally configured to engage a mounting portion attachment portion of a second body portion.

In some embodiments, the body portion attachment portion of the top portion may be structurally configured to engage a top portion attachment portion of the second body portion so as to provide a multi-configurable device that permits stacking of the body portion and the second body portion so as to provide increased connection density of the device without increasing a footprint of the mounting portion on the surface.

In some embodiments, the mounting portion may be structurally configured to be removably attached to the body portion.

In some embodiments, the mounting portion may include a body portion attachment portion structurally configured to attach to a mounting portion attachment portion of the body portion.

In some embodiments, the body portion further may include a body back wall portion and a body side wall portion that is structurally configured to extend from the body back wall portion.

In some embodiments, the body side wall portion may include a wall extension that includes the top portion attachment portion.

In some embodiments, the top portion may include a top wall portion and the body side wall portion may include a recessed portion structurally configured to receive at least a portion of the top wall portion.

In some embodiments, an outer surface of the top wall portion may align with an outer surface of the body portion side wall portion when the top portion is attached to the body portion.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 is a perspective view of an exemplary device of stackable multimedia outlet boxes in accordance with various aspects of the disclosure.

FIG. 2 is an exploded perspective view of the device of FIG. 1.

FIG. 3 is an exploded perspective view of a portion of the device of FIG. 1.

FIG. 4 is a top front perspective view of a first embodiment of a main body of the device of FIG. 1.

FIG. 5 is a bottom rear perspective view of a second embodiment of a main body of the device of FIG. 1.

FIG. 6 is a side view of the device of FIG. 1.

FIG. 7 is a sectional view of the device of FIG. 1 along section line VII-VII in FIG. 6.

FIG. 8 is an enlarged portion of the sectional view of FIG. 7.

### DETAILED DESCRIPTION OF EMBODIMENTS

Embodiments of the disclosure may provide a telecommunications outlet device that permits stacking of multiple body portions to provide improved connection density. Embodiments may include one or more body portions and a top portion. Embodiment may provide an engagement of a protrusion or a catch of a main body portion and a clip portion of a top portion, and an engagement of a protrusion or catch of a mounting portion or back plate and a clip portion of the main body portion for attaching parts of the device together when stacked.

Embodiments of the telecommunications outlet device may be designed for hybrid cabling (fiber strands for data and copper conductors for power) but embodiments need not be limited to this specific type of cabling nor the specific connectors used.

Examples of the device may include a stack or two body portions (e.g., boxes) with a top portion (e.g., a cover) and an accessory back portion (e.g., back plate). The back portion may be an accessory item and is not required for installation. Thus, the back portion or back plate may include a mounting portion structurally configured to mount the device to a surface and/or the body portion may include a mounting portion structurally configured to mount to a surface for mounting the device to the surface. In embodiments, the back portion has slack management features that are configured to store slack in cables.

Embodiments may include multiple body portions. Each body portion may include receiving clips (e.g., four clips) (as does the back plate) allowing for additional body portions to be mounted. The body portions may have separate rear entry pass throughs (as does the back plate) for fiber and copper (power) cables. In some embodiments, the pass throughs in the body portion and the back portion may be aligned to facilitate a cable passing through a body portion. In some embodiments, the body portions may be structurally configured to receive one or more connector body or adapter. For example, the adapter could be LC quad, SC duplex, or any of a variety of different adapters depending on the user's needs. In embodiments, features for the management of the fiber and copper (power) may include fiber slack management spool, fiber splice holders, a dedicated copper slack management, tie downs to hold the cable with tie wraps when using side entries, screw mounting holes, and tabs for holding the cable components in place are provided in the body portion.

Embodiments may provide a telecommunications outlet device that is configured to provide improved connection density of the outlet device without increasing a footprint of the mounting portion on the surface (e.g., a base size of the outlet device). Embodiments of the telecommunications outlet device may include a mounting portion structurally configured to be mounted to a surface (e.g. a wall or communication or utility box), a body portion defining an interior volume, and a top portion structurally configured to attach to the body portion.

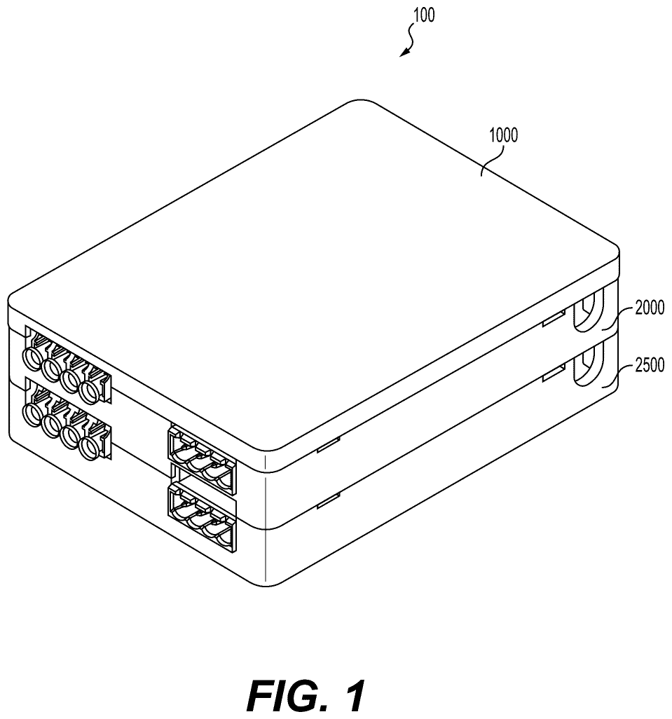

FIG. 1 shows an example of a device 100 that includes a top portion, for example, a top 1000, a first body portion or box 2000, and a second body portion or box 2500. Not visible in FIG. 1 is a back portion or back plate 3000 that is positioned on an underside of the second box 2500.

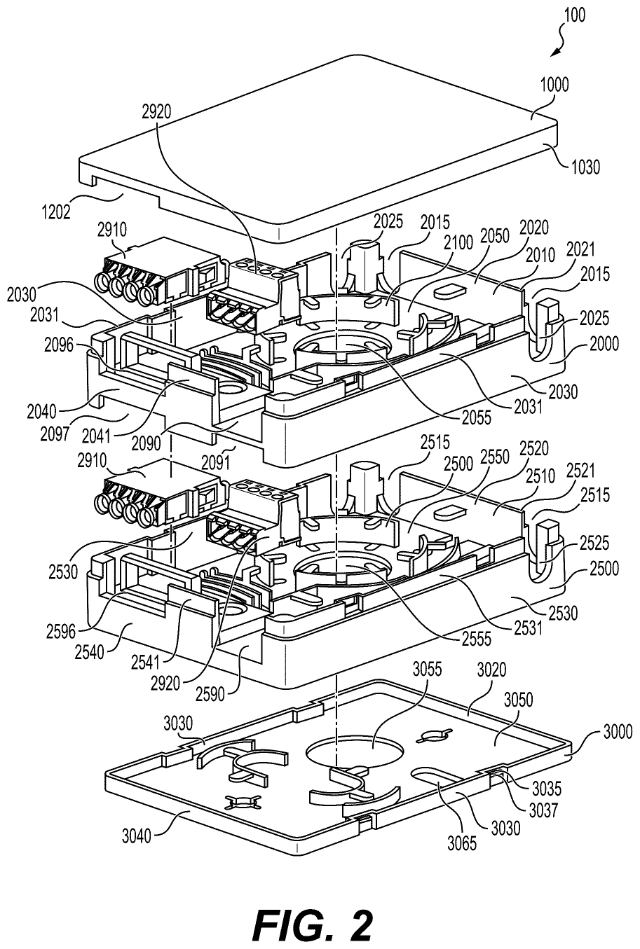

FIG. 2 shows the device 100 in an exploded view. FIG. 2 shows various features of this embodiment that enable the various parts (the top 1000, the first box 2000, the second box 2500, and the back plate 3000) to be removably attached to each other in a stacked arrangement. The stacked configuration allows one or more (in this example, two) main bodies to be stacked on to each other, which allows for increased connection density (e.g., the number of copper data connectors and/or fiber connectors supported by the device 100) while maintaining the same footprint. In this example, the footprint of the device may be the footprint of the second box 2500, which is equal to the footprint (e.g., the perimeter) of the back plate 3000 plus a small thickness of an overlapping portion of a side wall of the second box 2500.

In some embodiments, the device 100 may be structurally configured to mount to an electrical or communication box (e.g., a single-gang rectangular electrical boxes). Standard electrical and communication boxes typically are rectangular and have a height up to approximately 4 inches (10.16 cm) and a width up to approximately 3 inches (7.62 cm). For example, in some embodiments, the device 100 may be structurally configured to mount to a device box having a height of approximately 3 inches (7.62 cm) and a width of approximately 2 inches (5.08 cm). In some embodiments, the device 100 may be structurally configured to mount to a utility box having a height of approximately 4 inches (10.16 cm) and a width of approximately 2.25 inches (5.72 cm).

In some embodiments, the footprint of the device 100 may be structurally configured to be equal to or larger than the size (height×width) of the electrical or communication box. For example, the device 100 may have a footprint or base size of is slightly larger (e.g., approximately ¼ and ½ inch extra on all sides) than the electrical or communication box to ensure the electrical or communication box, and the hole into which electrical or communication box is mounted, is fully covered. In some embodiments, the device 100 may have a height of approximately 4.8 inches (12.19 cm) and a width of approximately 3.5 inches (9.24 cm), or an area of approximately 16.8 in2 (108.39 cm²), which may be large enough to cover most standard electrical and communication boxes (e.g., single-gang rectangular electrical boxes). While the illustrated examples of the device 100 have a rectangular shape, other embodiments may have shapes other than rectangular.

In some embodiments, the first box 2000 may be structurally configured to support a first maximum number of connectors. The first maximum number of connectors may be constrained by connector type, available structure to support the connectors, the size of the internal volume of the first box 2000 to hold slice holders and manage cable, etc. Further, the second box 2500 may be structurally configured to support a second maximum number of connectors, which may be the same or different from the first maximum number of connectors. Since the device 100 may be structurally configured to allow the second box 2500 to be attached to the first box 2000 in a stacked arrangement, the maximum number of connectors of the device may be increased (i.e., first maximum number of connectors+the second maximum number of connectors) without increasing the footprint of the device, thus increasing the connection density. In a similar fashion, the additional boxes may be added to the stacked arrangement in a similar fashion to further increase the connection density.

For example, in some embodiments, the first box 2000 may be structurally configured to support four fiber connectors and four copper connectors (via adapters 2910 and 2920) as shown in FIG. 2 and have a height of approximately 4.8 inches (12.19 cm) and a width of approximately 3.5 inches (9.24 cm). Further the second box 2500 may be structurally configured to support four additional fiber connectors and four additional copper connectors (via adapters 2910 and 2920) and have a height of approximately 4.8 inches (12.19 cm) and a width of approximately 3.5 inches (9.24 cm). In other embodiments, however, the first box 2000 and the second box 2500 may be structurally configured to support more or less fiber and/or copper connectors (e.g., 8 fiber and 8 copper connectors), such as for example, with alternate connectivity. When the first box 2000 and the second box 2500 are attached in a stacked arrangement, the device 100 may be structurally configured to support eight fiber connectors and eight copper connectors within the same footprint of approximately 4.8 inches (12.19 cm) and a width of approximately 3.5 inches (9.24 cm).

In the example shown in FIG. 2, the top 1000 has a top wall portion or skirt portion, for example, skirt 1030 that extends downward to engage an upper area of the first box 2000. In this example, the skirt 1030 has an adapter opening, or cut-out, 1202 that, with a corresponding adapter opening 2096 in the first box 2000, forms a receptacle for an adapter, or other device, 2910.

FIG. 2 shows the first box 2000 having a body portion or main body 2010 that includes side wall portion or side walls 2020, 2030, 2040, and a back wall portion or back wall 2050. In this example, the side wall 2020 includes two openings, for example, cable entry openings 2015, that are structurally configured to provide entry points to the first box 2000 for communication cables such as, for example, optical fiber cables and/or copper conductors. In this example, the side walls 2030 each include one opening, for example, a cable entry opening 2025, that is structurally configured to provide an entry point to the first box 2000 for communication cables such as, for example, optical fiber cables and/or copper conductors.

In this example, the first box 2000 includes a cable passthrough 2055 and (not visible in FIG. 2) a cable passthrough 2065. The two separate cable pass throughs 2055, 2065 are provided so that, for example, fiber optic cables (or fibers) can be routed in a separate pass through than power cables. This can be advantageous in that it reduces the likelihood of power cables damaging or interfering with fiber optic cables or fibers. Also shown in FIG. 2 are a plurality of cable guides 2100 that provide structure to organize and route cables inside the first box 2000.

In this example, two adapter openings 2096, 2090 are provided in the side wall 2040 at an end of the box 2000 opposite to the end where the cable entry openings 2015, 2025 are provided. As stated above, the adapter opening 2096 corresponds to the adapter opening 1202 in the top 1000 to form an opening for receiving an adapter such as, for example, adapter 2910. In this example, the adapter opening 2090 does not have a corresponding adapter opening in the top 100 to form an opening for receiving an adapter such as, for example, adapter 2920. In other examples, fewer or more adapter openings and/or different adapter openings are provided in the first box 2000. This example of the first box 2000 includes an adapter opening 2097 that is configured to correspond to an adapter opening 2596 in the second box 2500 to form an opening for, for example, an adapter 2910. Similarly, this example of the first box 2000 includes an adapter opening 2091 that is configured to correspond to an adapter opening 2590 in the second box 2500 to form an opening for, for example, an adapter 2920.

Thus, in some embodiments, the first box 2000 includes both cable receiving portions (e.g., cable entry openings 2015, 2025) and distribution portions (e.g., adapter openings 2090, 2096 for supporting adapters 2910, 2920). Thus, the cable receiving portions and the distribution portions for the cable may be in the same layer in the stacked configuration.

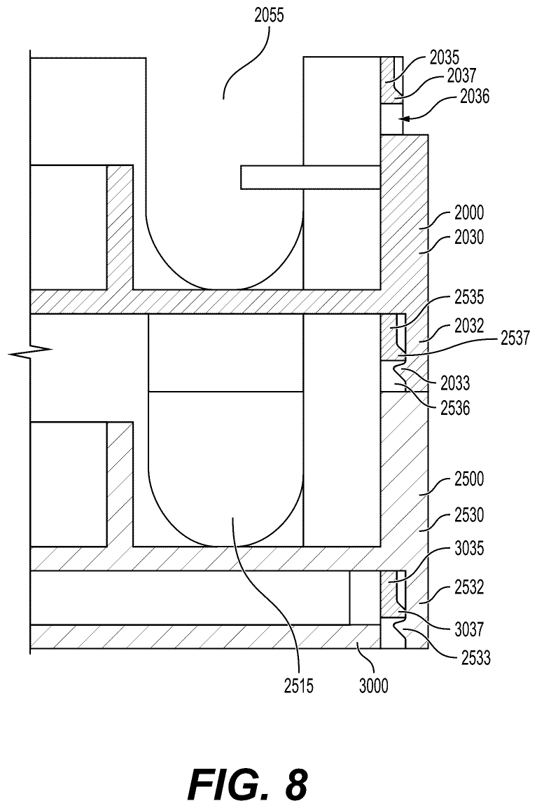

FIG. 2 shows an example of structure (e.g., a body portion attachment portion) that allows the top 1000 to be removably attached to the first box 2000. In this example, the side walls 2020, 2030, 2040 of the first box 2000 have a recessed portion 2021, 2031, 2041 that is structurally configured to receive and cooperate with the skirt 1030 of the top 1000. The top 1000 may be retained in the position shown in FIG. 1 by various structure that will be discussed below in detail with reference to FIGS. 7 and 8.

FIG. 2 shows the second box 2500, which is similar to the first box 2000. This example of the second box 2500 is shown having a body portion or main body 2510 that includes side wall portions or side walls 2520, 2530, 2540, and a back wall portion or back wall 2550. In this example, the side wall 2520 includes two openings, for example, cable entry openings 2515, that are structurally configured to provide entry points to the second box 2500 for communication cables such as, for example, optical fiber cables and/or copper conductors. In this example, the side walls 2530 each include one opening, for example, a cable entry opening 2525, that is structurally configured to provide an entry point to the second box 2500 for communication cables such as, for example, optical fiber cables and/or copper conductors. In this example, the second box 2500 includes a cable passthrough 2555 and (not visible in FIG. 2) a cable passthrough 2565. The two separate cable pass throughs 2555, 2565 are provided so that, for example, fiber optic cables (or fibers) can be routed in a separate pass through than power cables. This can be advantageous in that it reduces the likelihood of power cables damaging fiber optic cables or fibers. Also shown in FIG. 2 are a plurality of cable guides 2500 that provide structure to organize and route cables inside the second box 2500. In this example, two adapter openings 2596, 2590 are provided in the side wall 2540 at an end of the second box 2500 opposite to the end where the cable entry openings 2515, 2525 are provided. As stated above, the adapter opening 2596 corresponds to the adapter opening 2097 in the first box 2000 to form an opening for receiving an adapter such as, for example, adapter 2910. In this example, the adapter opening 2590 corresponds to the adapter opening 2091 in the first box 2000 to form an opening for receiving an adapter such as, for example, adapter 2920. In other examples, fewer or more adapter openings and/or different adapter openings are provided in the second box 2500. This example of the second box 2500 does not include adapter openings such as adapter openings 2097 or 2091 because it is configured to attach to the back plate 3000.

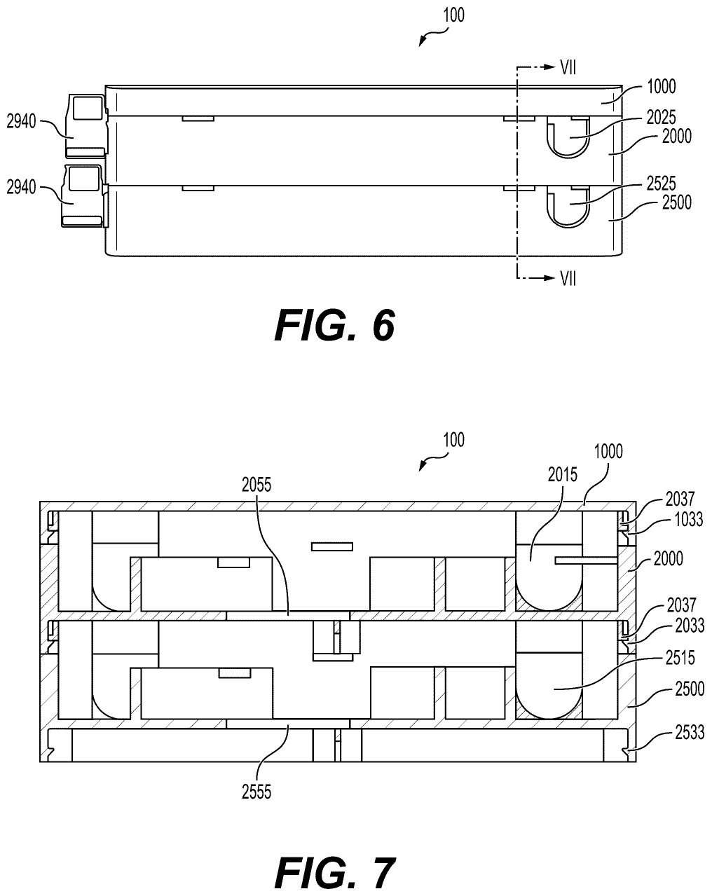

The adapter openings described herein may receive and support the adapters, as described above, which may be configured to connect to connectors 2940 (FIG. 6). Thus, in some embodiments, the device 100 may be structurally configured to hold the adapters, and support the connectors, without additional or separate components since the structure supporting the adapters is built directly into the body portions.

FIG. 2 shows an example of structure (e.g., a mounting portion attachment portion or body portion attachment portion) that allows the first box 2000 to be removably attached to the second box 2500. In this example, the side walls 2520, 2530, 2540 of the second box 2500 have a recessed portion 2521, 2531, 2541 that is structurally configured to receive and cooperate with lower portions of the side walls 2020, 2030, 2040 of the first box 2000. The first box 2000 is retained in the position shown in FIG. 1 by various structure that will be discussed below in detail with reference to FIGS. 7 and 8.

Although the example shown in the drawings has only the first box 2000 and the second box 2500, other numbers of boxes 2000, 2500 can be used. In this example, the first box 2000 is used adjacent to the top 1000 and the second box 2500 is used adjacent to the back plate 3000. In examples where a third box is used, the third box would be another box 2000 so that the adapter openings 2097 and 2091 are provided to correspond to the adapter openings 2096 and 2090, respectively.

FIG. 2 shows the back plate 3000 having side wall portions or side walls 3020, 3030, 3040 and a back wall portion or back wall 3050. Similar to the first box 2000 and the second box 2500, the back plate 3000 has a cable passthrough 3055 and (not visible in FIG. 2) a cable passthrough 3065. The two separate cable pass throughs 3055, 3065 are provided so that, for example, fiber optic cables (or fibers) can be routed in a separate pass through than power cables.

FIG. 2 shows an example of structure (e.g., a mounting portion attachment portion) that allows the second box 2500 to be removably attached to the back plate 3000. In this example, the side walls 3020, 3030, 3040 of the back plate 3000 are structurally configured to fit inside of the sidewalls 2520, 2530, 2540 of the second box 2500, as more clearly shown in FIG. 8. The second box 2500 is retained in the position shown in FIG. 8 by various structure, examples of which will be discussed below in detail with reference to FIGS. 7 and 8.

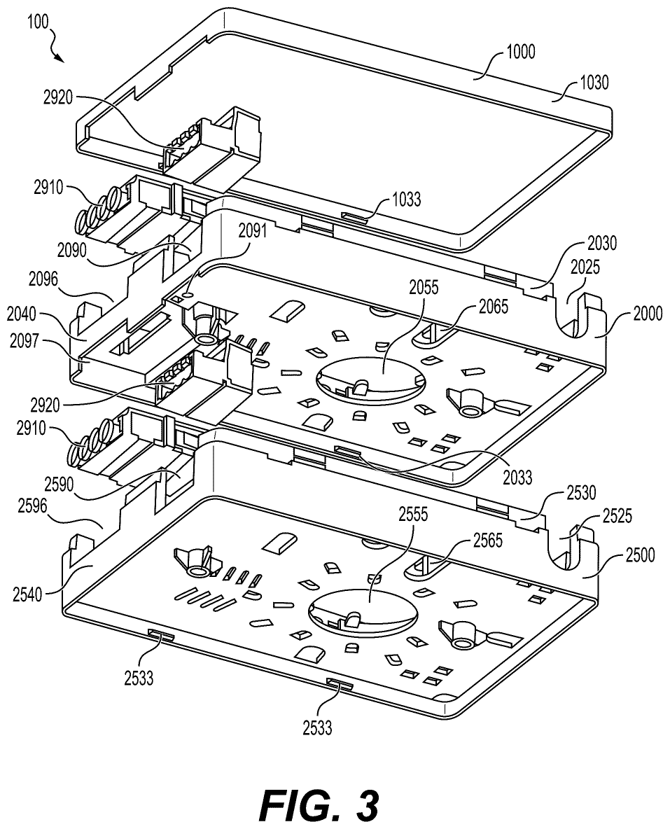

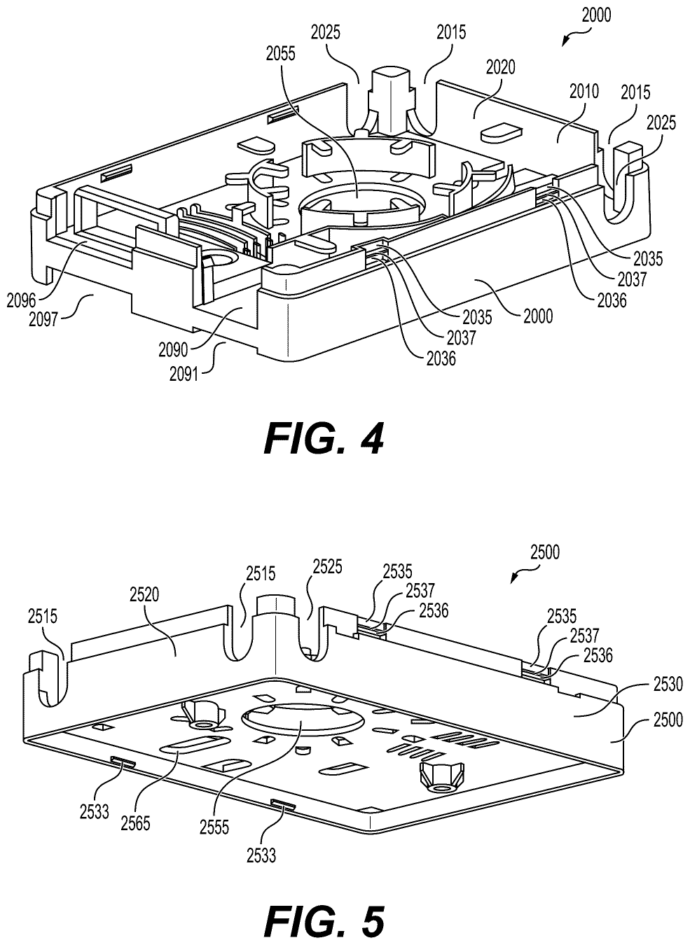

FIG. 3 is a bottom perspective view of the device shown in FIG. 2 that shows features of the undersides of the top 1000, the first box 2000, and the second box 2500. FIG. 4 shows the first box 2000, including the attachment portion structure (e.g., attachment portions) that will be discussed below in detail with reference to FIGS. 7 and 8. FIG. 5 shows the second box 2500, including the attachment structure, examples of which will be discussed below in detail with reference to FIGS. 7 and 8.

FIG. 6 shows the device 100 of FIG. 1 with connectors 2940 attached to the adapters 2910 and/or 2920. FIG. 7 is a sectional view of the device 100 taken along section line VII-VII in FIG. 6. FIG. 7 shows an engagement portion, for example, a clip 1033, on the top 1000 that engages with the first box 2000 to removably attach the top 1000 to the first box 2000. FIG. 7 also shows an engagement portion, for example, a clip 2033, on the first box 2000 that engages with the second box 2500 to removably attach the first box 2000 to the second box 2500. FIG. 7 further shows an engagement or attachment portion, for example, a clip 2533, on the second box 2500 that engages with the back plate 3000 to removably attach the second box 2500 to the back plate 3000.

The example attachment structure between the various components of the device 100 will now be discussed with reference to FIG. 8. FIG. 8 is a partial sectional view showing the first box 2000, the second box 2500, and the back plate 3000. With reference to FIGS. 7 and 8, the clips 1033 (in this case, four clips 1033) of the top 1000 each engage a recess or opening 2036 in the side wall 2030 of the first box 2000. In this example, the recess 2036 is in a wall extension 2035 at the upper end of the side wall 2030. A protrusion or catch 2037 extends from the wall extension 2035 above the recess 2036.

As shown in FIG. 7, the clip 1033 engages the catch 2037 to resist removal of the top 1000 from the first box 2000. In this example, the skirt 1030 of the top 1000 elastically deforms outwardly to allow the clip 1033 to pass over the catch 2037 and then move inwardly to engage the recess 2036. The top 1000 can be removed by pulling the top 1000 away from the first box 2000 with sufficient force for the skirt to deflect outwardly so that the clip 1033 is moved out of engagement with the recess 2036 and over the catch 2037.

In some embodiments, the first box 2000 is removably attached to the second box 2500 in a similar manner as the top 1000 is removably attached to the first box 2000. Specifically, the clips 2033 (in this case, four clips 2033) at a lower portion 2032 of the side wall 2030 of the first box 2000 each engage a recess or opening 2536 in the side wall 2530 of the second box 2500. In this example, the recess 2536 is in a wall extension 2535 at the upper end of the side wall 2530. A protrusion or catch 2537 extends from the wall extension 2535 above the recess 2536. As shown in FIG. 7, the clip 2033 engages the catch 2537 to resist removal of the first box 2000 from the second box 2500.

In some embodiments, to attach the first box 2000 to the second box 2500, the first box 2000 may be pressed onto the second box 2500 (e.g., moved linearly toward the second box 2500) such that the lower portion 2032 of the side wall 2030 of the first box 2000 is received over the wall extension 2535 at the upper end of the side wall 2530 of the second box 2500 (e.g., the lower portion 2032 laterally overlaps the upper end of the sidewall 2530). In this example, the lower portion 2032 of the side wall 2030 elastically deforms outwardly to allow the clip 2033 to pass over the catch 2537 and then move inwardly to engage the recess 2536. The first box 2000 can be removed by pulling the first box 2000 away from the second box 2500 with sufficient force for the side wall 2030 to deflect outwardly so that the clip 2033 is moved out of engagement with the recess 2536 and over the catch 2537.

In some embodiments, the second box 2500 is removably attached to the back plate 3000 in a similar manner as the first box 2000 is removably attached to the second box 2500. Specifically, the clips 2533 (in this case, four clips 2533) at a lower portion 2532 of the side wall 2530 of the second box 2500 each engage a protrusion or catch 3037 in the side wall 3030 of the back plate 3000. As shown in FIG. 7, the clip 2533 engages the catch 3037 to resist removal of the second box 2500 from the back plate 3000. In this example, the lower portion 2532 of the side wall 2530 elastically deforms outwardly to allow the clip 2533 to pass over the catch 3037. The second box 2500 can be removed by pulling the second box 2500 away from the back plate 3000 with sufficient force for the side wall 2530 to deflect outwardly so that the clip 2533 is moved out of engagement with, and over, the catch 3037.

In some embodiments, the attachment portions may be positioned at, or adjacent, an outer periphery of the top 1000, the first box 2000, the second box 2500, and the back plate 3000. For example, as described above, the top 1000 may include a body portion attachment portion on a top side wall portion (e.g., the clips 1033 on the skirt 1030) structurally configured to engage a top portion attachment portion on a body portion side wall portion (e.g., the recess 2036 is in a wall extension 2035 at the upper end of the side wall 2030 and the protrusion or catch 2037 extending from the wall extension 2035 above the recess 2036). Thus, in some embodiments, the attachment portions allow for direct connection between portions (e.g., the top 1000 to the first box 2000, the first box 2000 to the second box 2500, etc.) without the need for additional layers between the portions while keeping an interior volume of the body portions (e.g., interior spaces of the first box 2000 and second box 2500) unencumbered by the attachment portions.

Further, in some embodiments, a portion of the body portion (e.g., the wall extension 2535 at the upper end of the side wall 2530 of the second box 2000) may be structurally configured to be received (e.g., nested) within a portion of an adjacent body portion or top portion (e.g.,

Although the example shown and described includes a specific configuration of the top 1000, the first box 2000, the second box 2500, and the base plate 3000, it is noted that the example attachment structure or portions of the disclosure is configured to accommodate other assemblies of various numbers and types of the top, boxes, and back plate. For example, different back plates can be used for different mounting applications such as, screwing or bolting to a wall, strapping to a pole or other tubular structure, and magnetic mounting.

The attachment portions (e.g., the engagement of the catches and the clips) provide a multi-configurable device that permits stacking multiple main bodies on the back plate to provide improved density. In some embodiments, the attachment portions are

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A telecommunications outlet device configured to be expanded to provide increased connection density, comprising:
a mounting portion structurally configured to be mounted to a surface and comprising a mounting portion side wall portion that includes a body portion attachment portion;
a body portion structurally configured to attach to the mounting portion and comprising a body back wall portion and a body side wall portion that is structurally configured to extend from the body back wall portion, wherein the body back wall portion and the body side wall portion are structurally configured to define an interior volume of the body portion, and wherein the body side wall portion comprises a mounting portion attachment portion that extends inwardly from the body side wall portion and a top portion attachment portion;
a top portion structurally configured to attach to the body portion and comprising a top wall portion and a body portion attachment portion that extends inwardly from the top wall portion;
wherein the body portion side wall portion is structurally configured to receive the body portion attachment portion of the top portion to attach the top portion to the body portion;
wherein the body portion attachment portion of the mounting portion side wall portion is structurally configured to engage the mounting portion attachment portion of the body side wall portion to attach the mounting portion to the body portion;
wherein the body side wall portion comprises a wall extension that includes the top portion attachment portion;
wherein the body portion attachment portion of the top portion includes a clip, and the top portion attachment portion of the body portion includes a protrusion adjacent a recess in the wall extension, and wherein the clip is structurally configured to engage the protrusion to resist removal of the top portion from the body portion; and
wherein the top portion is structurally configured to be detached from the body portion, the top portion attachment portion of the body portion is structurally configured to engage a mounting portion attachment portion of a second body portion, and the body portion attachment portion of the top portion is structurally configured to engage a top portion attachment portion of the second body portion such that the second body portion is permitted to be stacked on the body portion so as to provide increased connection density of the device without increasing a footprint of the mounting portion on the surface.

2. The device of claim 1, wherein the mounting portion comprises a back plate.

3. The device of claim 1, wherein an outer surface of the top wall portion is configured to be aligned with an outer surface of the body portion side wall portion when the top portion is attached to the body portion.

4. The device of claim 1, wherein the body portion side wall portion comprises one or more cable entry openings.

5. The device of claim 1, wherein the body back wall portion includes one or more cable passthrough openings structurally configured to connect the interior volume of the body portion to an interior volume of the second body portion.

6. The device of claim 1, wherein the top wall portion of the top portion is structurally configured to elastically deform outwardly to allow the clip to pass over the catch and then move inwardly to engage the recess.

7. The device of claim 1, wherein the top wall portion includes a first adapter opening and the body wall portion includes a second adapter opening that together form a receptacle for receiving an adapter.

8. A telecommunications outlet device configured to be expanded to provide increased connection density, comprising:
a top portion comprising a body portion attachment portion;
a body portion structurally configured to attach to the top portion, the body portion defining an interior volume for receiving one or more communication cables, the body portion comprising a top portion attachment portion; and a mounting portion associated with the body portion, the mounting portion structurally configured to mount the device to a surface;
wherein the top portion attachment portion of the body portion is structurally configured to engage a mounting portion attachment portion of a second body portion, and the body portion attachment portion of the top portion is structurally configured to engage a top portion attachment portion of the second body portion so as to provide a multi-configurable device that permits stacking of the body portion and the second body portion so as to provide increased connection density of the device without increasing a footprint of the mounting portion on the surface.

9. The device of claim 8, wherein the mounting portion is structurally configured to be removably attached to the body portion.

10. The device of claim 9, wherein the mounting portion includes a body portion attachment portion structurally configured to attach to a mounting portion attachment portion of the body portion.

11. The device of claim 10, wherein the body portion further comprises a body back wall portion and a body side wall portion that is structurally configured to extend from the body back wall portion.

12. The device of claim 11, wherein the body side wall portion comprises a wall extension that includes the top portion attachment portion.

13. The device of claim 8, wherein the top portion comprises a top wall portion and the body side wall portion comprises a recessed portion structurally configured to receive at least a portion of the top wall portion.

14. The device of claim 8, wherein an outer surface of the top wall portion is aligned with an outer surface of the body portion side wall portion when the top portion is attached to the body portion.

15. A telecommunications outlet device configured to be expanded to provide increased connection density, comprising:
a top portion;
a body portion structurally configured to attach to the top portion, the body portion defining an interior volume for receiving one or more communication cables;
a mounting portion associated with the body portion, the mounting portion structurally configured to mount the device to a surface; and
wherein the body portion and the top portion are structurally configured to mount a second body portion that is configured to define a second interior volume between the top portion and the body portion in a stacked configuration such that the second body portion is attached to both the body portion and the top portion.

16. The device of claim 15, wherein the body portion defines a footprint and the second body portion fits within the footprint.

17. The device of claim 15, wherein the body portion includes an opening structurally configured to connect an interior volume of the body portion to the second interior volume of the second body portion.

18. The device of claim 15, wherein the mounting portion includes a body portion attachment portion structurally configured to attach to a mounting portion attachment portion of the body portion.

19. The device of claim 15, wherein the body portion further comprises a body back wall portion and a body side wall portion that is structurally configured to extend from the body back wall portion.

20. The device of claim 19, wherein the body side wall portion comprises a wall extension that includes the top portion attachment portion.

21. The device of claim 20, wherein the top portion includes a clip, and the body portion includes a protrusion adjacent a recess in the wall extension, and wherein the clip is structurally configured to engage the protrusion to resist removal of the top portion from the body portion.

22. The device of claim 15, wherein the top portion comprises a top wall portion and the body side wall portion comprises a recessed portion structurally configured to receive at least a portion of the top wall portion.
